(19) United States
(12) Patent Application Publication
(10) Pub. No.: US 2003/0223119 A1
(43) Pub. Date: Dec. 4, 2003

(54) Water and dust resistant laptop case

(76) Inventor: Marc Heiman, New York, NY (US)

Correspondence Address: NOTARO AND MICHALOS, 100 DUTCH HILL ROAD, SUITE 110, ORANGEBURG, NY, 10962-2100, US

(21) Appl. No.: 10/156,380

(22) Filed: May 28, 2002

(51) Int. Cl. G02B 27/00; G02B 5/08; G02B 17/00; G02B 21/00; G02B 23/16

(52) U.S. Cl. 359/610; 359/601; 359/608; 359/613

(57) ABSTRACT

A water and dust resistant laptop case with privacy features has a housing with a base and a cover connected to the base at a rear wall of the base. A height adjustment mechanism in the base sets a vertical position of the laptop in the base and slots are provided in a rear and a pair of side walls of the base for connecting power and/or peripherals to the laptop. A clear display shield inside the cover can be brought in front of the laptop display when the laptop is open. A visor assembly is pivotally connected to the cover near a top edge of the cover for movement between a storage position that is substantially parallel to the cover and a shading position extending outwardly from the cover. The visor assembly can be held in the shading position. A flexible keyboard shield also extends over the keyboard of the laptop.

### FIELD AND BACKGROUND OF THE INVENTION

The present invention relates generally to the field of bags and cases for delicate electronic equipment, and in particular to a new and useful laptop case assembly which is water and dust resistant, and has a privacy feature as well.

As laptop computers have become more powerful, portable and versatile, they have been brought out of the safe, dry and generally dust-free environment of the home or office, and into environments that are hostile to electronic equipment, such as on a boat where the laptop can be used in conjunction with a GPS (Global Positioning System), or at a construction site for use with construction plans and schedules. In such environments, the laptop would be exposed to water and/or dust which would likely damage this delicate piece of equipment.

U.S. Pat. No. 5,931,297 to Weill et al. discloses a protective cover for a notebook or laptop computer with a top portion for accommodating a notebook display, and a bottom portion for accommodating the keyboard portion of the notebook computer. The notebook computer is inserted, while closed, into the cover via a back end member, which has a sealable opening and a sleeve.

U.S. Pat. No. 6,149,001 to Akins discloses a cover for a portable computer including a top cover and a base cover. In one embodiment, the upper section is pivotally connected to the base section. The base section has rear and side walls and a plurality of openings aligned with components of the portable computer such as a mouse PS/2 port, a power switch, and other ports and buttons.

U.S. Pat. No. 5,877,896 to Gremban discloses a case for housing a laptop computer, with an attached visor and side shade panels. A product sold under the trademark “Private Eye” appears to correspond to this patent. Top and side shade panels hinged to the case back make the laptop display easier to read.

U.S. Pat. No. 5,887,723 to Myles et al. discloses a protective carrying bag which allows a user to carry as well as operate a portable computer without removing the computer from the bag. The bag has opposing front and back walls and an opening in the front wall for viewing access to the display of the laptop computer lying within the bag.

U.S. Pat. No. 5,214,574 to Chang discloses a protective housing for a portable computer comprising two pivotally jointed shells for encasing the computer. The housing is configured to accommodate the CPU and display in only one shell. The second shell houses other peripherals such as a portable printer. The walls of the second shell are designed to interlock with those of the first shell to provide a compact rectangular housing when the shells meet and the housing is closed for transport and storage.

U.S. Pat. No. 5,682,993 to Song discloses a portable and water-resistant computer cover formed by upper and lower rectangular trays joined by a zipper. The computer remains attached to and partially enclosed by the trays while being operated, and may be connected to external devices and cables via apertures formed in at least one of the trays. Elastic flaps equipped with snap fasteners cover the apertures when not in use.

U.S. Pat. No. 5,697,718 to Erler et al. shows a portable computer housed in an impact attenuating case with a sealed keyboard for protection against harsh environments. Top and bottom coverings are affixed to the display and base sections of a portable computer. The keyboard assembly is formed by a plastic key tray, a contiguous sheet of water impervious resilient elastomeric material and a keyboard circuit board. The key tray, sheet of material, and circuit board are fastened together as a subassembly, seated in the base portion of the laptop and secured from above by a keyboard bezel. The sheet of membrane material has a plurality of in-molded raised dimples that are formed beneath each key, serving as a spring that ensures biasing apart of keys in a relaxed state. When a user depresses a key, the dimple is compressed which brings the key in close proximity to the key circuit board, where its motion is detected.

Patents also exist that disclose foldable and removable visors and hoods for protecting a laptop from environmental conditions while providing shade for the display.

U.S. Pat. No. 5,717,566 to Tao discloses a visor for notebook computers, comprising a bracket for mounting the visor, a top panel hinged to the bracket, and side panels hinged to the top panel and bracket.

U.S. Pat. No. 5,905,546 to Giulie discloses a detachable and foldable visor for use on a laptop. The visor has a central top panel and foldable side panels adapted to extend across the top and sides of the monitor. The side panels can be folded along a plurality of parallel axes with respect to the central top panel for adaptability to monitors of different width. The visor is held on a laptop display by mounting tabs connected to the inside of the side panels which retain a flexible material such as a rubber band to hold the visor onto the monitor.

U.S. Pat. No. 6,084,711 to Duff discloses a foldable shade for a laptop, in the form of a four sided collapsible box with an open front end for allowing viewing of a display.

U.S. Pat. No. 6,353,531 to Howell et al. shows a notebook computer with an integrated visor. The display panel of the notebook computer is housed by a cover pivotally connected to the base for movement between an open and closed position. A visor is provided at the outer edges of the cover, which is comprised of right and left flanges extending in a direction perpendicular to the display panel of the notebook computer.

U.S. Pat. No. 5,988,823 to Wong discloses a laptop hood provided in the form of a sheet with panels, flaps, fold lines, and an opening through which a laptop display may be viewed. The single sheet can be folded into a three dimensional operational configuration or a compact non-operational storage configuration. The laptop hood allows the laptop keyboard to remain outside of the hood compartment area. Side panels enable the hood to stand freely. A front panel of the configuration can be flipped up to the roof of the hood leaving an opening for viewing the display and can be flipped down to enclose the laptop for storage.

Several patents also disclose keyboard covers that protect a keyboard. For example, U.S. Pat. No. 6,050,825 to Nichol et al. discloses an opaque computer keyboard cover for covering only the alphanumeric keys. The cover is thermo-molded and flexible, so that pressure on the molded keys activate individual keys on the keyboard. U.S. Pat. No. 5,551,497 to Stanley teaches a computer keyboard cover configured to conform to the general size and shape of the computer keyboard.

Other patents disclose other protective devices for laptops and computers in general. All of the know prior art is distinguishable from the present invention in important ways.

A patent search conducted for the applicant raveled the forgoing and addition patents of interest.

For convenience all of the patents are here listed:

| U.S. Pat. No. | Inventor(s) |
|---|---|
| 5,096,317 | Phillippe |
| 5,115,345 | Hobson et al. |
| 5,121,253 | Waintroob |
| 5,214,574 | Chang |
| 5,233,468 | NcNulty |
| 5,237,453 | Jones |
| 5,243,463 | Waintroob |
| 5,400,903 | Cooley |
| 5,527,122 | Carter |
| 5,551,497 | Stanley |
| 5,682,993 | Song |
| 5,697,718 | Erler et al. |
| 5,717,566 | Tao |
| 5,810,491 | Muller et al. |
| 5,835,342 | Hunte |
| 5,877,896 | Gremban |
| 5,887,723 | Myles et al. |
| 5,905,546 | Giulie et al. |
| 5,931,297 | Weill et al. |
| 5,988,823 | Wong |
| 6,046,754 | Stanek |
| 6,050,825 | Nichol et al. |
| 6,084,711 | Duff |
| 6,149,001 | Akins |
| 6,273,623 | Chao |
| 6,353,531 | Howell et al. |
| 6,354,210 | Chao |

### SUMMARY OF THE INVENTION

It is an object of the present invention to provide a laptop case which effectively and efficiently protects the laptop from water and dust specifically, and generally allows the laptop to be used in outside or harsh environments such as on a boat or at a construction site. A privacy feature is also provided by the invention.

Accordingly, another object of the present invention is to provide a water and dust resistant laptop case that has a housing with a base and a cover connected to the base at a rear wall of the base. A height adjustment mechanism in the base sets a vertical position of the laptop in the base and slots are provided in rear and a pair of side walls of the base for connecting power and/or peripherals to the laptop. A clear display shield inside the cover can be brought in front of or over the laptop display when the laptop is open. A visor assembly is pivotally connected to the cover near a top edge of the cover for movement between a storage position that is substantially parallel to the cover and a shading position extending outwardly from the cover. The visor assembly can be held in the shading position and provide both protection and privacy for the user. A flexible keyboard shield also extends over the keyboard of the laptop.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a perspective view of a laptop case according to the present invention, in the open position with the laptop open, its display covered by a clear display shield and a visor assembly fully deployed in preparation for installing a keyboard shield over the laptop keyboard;

FIG. 2 is a front sectional view of the case in a closed position for the case and laptop;

FIG. 3 is a view similar to FIG. 2 but with the case and laptop open and illustrating another embodiment of the invention;

FIG. 4 is a partial perspective view of another embodiment of the invention;

FIG. 5 is a front section through a laptop case base, illustrating another embodiment of the height adjustment means of the invention; and

FIG. 6 is a partial side elevation of the embodiment of FIGS. 4 and 5.

### DESCRIPTION OF THE PREFERRED EMBODIMENTS

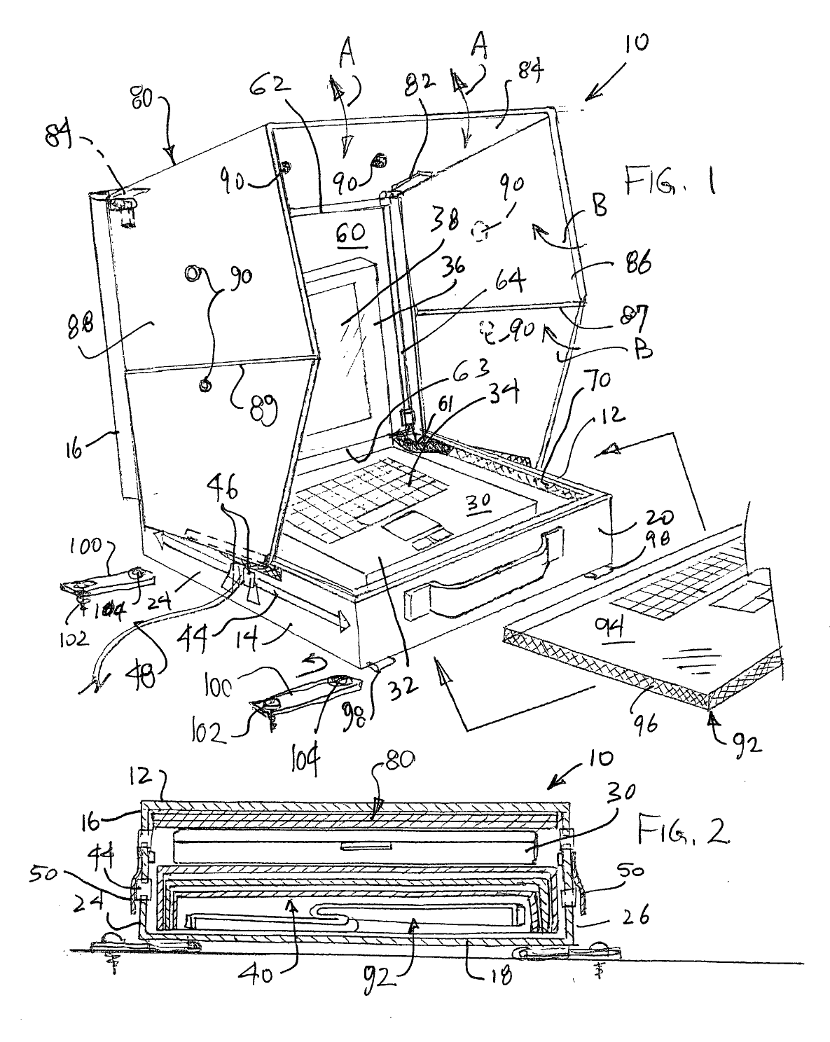

Referring now to the drawings in which like reference numerals are used to refer to the same or functionally similar elements, the invention embodied in FIG. 1 comprises water and dust resistant laptop case generally designated 10, having a housing 12 with a base or base portion 14 and a cover or cover portion 16.

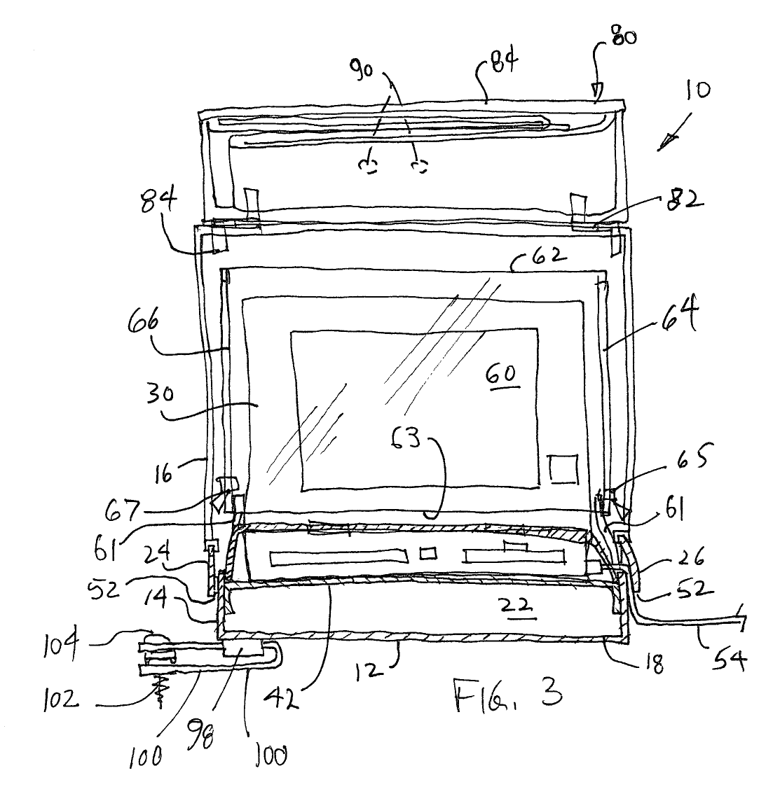

Base 14 has a bottom wall 18, a front wall 20, a rear wall 22 and a pair of side walls 24 and 26. The walls, which are made of suitably flexible but strong, water and dust resistant material such as CORDURA (a trademark) Nylon fabric, define a storage space for a laptop 30. Laptop 30 has a body 32 with a keyboard 34 and a lid 36 with a display 38, hinged to the body and movable, in a know way, between an open position shown in FIGS. 1 and 3, and a closed position shown in FIG. 2.

The housing cover 16 is connected to the base 14 at the top edge of the rear wall 22, where the flexible material between the base and cover form a fold line so that the cover can have a closed position over the base as in FIG. 2, for closing the storage space, and an open position as in FIGS. 1 and 3, extending upwardly from the rear wall of the base.

Height adjustment means 40 are provided in the storage space for adjusting a vertical position of the laptop. In FIG. 2 these means are formed by a set, e.g. three, of nested rectangular trays that are rigid and have flat tops for supporting the laptop and downwardly extending sides or legs of different heights. The user of the case selects the tray of appropriate height to support the laptop in the base. Laptops with thicker bodies will need lower trays so that the keyboard 34 is just below the top edge of base 14 when the lid 36 is open as in FIG. 1.

In another embodiment of the invention illustrated in FIG. 3, the height adjustment means are in the form of a single tray 42 with an up-or downwardly extending perimeter provided with one type of mating fastening tape, e.g. VELCRO (a trademark) hook or loop tape. This tape mates with another loop or hook tape provided on the inside surfaces of front and side walls 20, 24 and 26, to hold the laptop body at the correct height inside the base 14. Alternative means for adjusting the height of the laptop body may be provided which may vary in type and strength depending on the size, weight and shape of the laptop.

Slot means are also provided to define access slots in at least one, but preferably all of the rear wall 22 and pair of side walls 24, 26, for connecting at least one power and/or peripheral to the laptop body. In FIGS. 1 and 2, the slot means are in the form of a double zippered slot 44, ending before the case corners, and having a pair of zipper pulls 46 that act in opposite directions to open and close any selected length and location of the slot for the passage of cords, cables, hardware parts or the like, schematically shown by cable 48. Sewn on weather flaps 50 at the side walls 24 and 26 are provided over the slots to help keep out rain and dust.

In FIG. 3 the slot means are VELCRO tape closed slots 52 between overlapping parts of the side walls 24, 26, that allow a cable 54 to pass from the laptop to a location outside the case 10.

A clear, flexible plastic display shield 60 is attached at its top horizontal edge 62, to the inside surface of cover 16. A pair of vertical zippers 64 and 66 or VELCRO fastening tapes or other fasteners, operate between the side edges of shield 60 and the inside surface of cover 16 via a pair of zipper pulls 65 and 67. Pulls 65, 67 are raised to release the shield 60 so that with the laptop lid 36 raised as in FIGS. 1 or 3 the shield can be brought up over the lid 36 and in front of the display 38. The pulls 65, 67 are then drawn down again to trap the laptop lid between the cover 16 and the shield 60. The lower edge 63 of shield 60 is left free to accommodate the laptop body 30 extending forwardly of the laptop lid 36. VELCRO tabs or tapes 61, or other fastening means are fixed to and extending downwardly from the lower edge 63 of shield 60 and can be pulled down and fastened to mating VELCRO tapes 70 provided on the inside, upper surfaces of the side walls 24 and 26, to help smooth and flatten the shield and hold it taught even in windy conditions. Laptop display 38 is clearly visible through the shield 60.

To address the potential problem of sun glare that would make the display 38 hard to see, the invention includes a visor assembly generally designated 80, that is pivotally connected to the top edge of cover 16, at a fold of fabric extending continuously between the visor assembly and the cover. This top edge of the cover is adjacent the front wall 20 of the base 14 when the cover is in the closed position of FIG. 2.

The visor assembly has a storage position shown in FIG. 2 that is substantially parallel to the cover and over the shield 60. The visor assembly 80 also has a shading position shown in FIG. 1, extending outwardly from the top edge of the cover when the cover is in the open position. Fixing means, such as a pair of friction hinges 82, 84, are provided between the cover 16 and the visor assembly 80 for holding the visor assembly in the shading position. Such hinges allow the assembly to be pulled up and down in the direction of arrows A in FIG. 1, but hold the assembly in the position selected. A company known as Torqmaster International of Stamford, Conn. (www.torqmaster.com) makes a suitable hinge for this purpose.

The visor assembly may include only a main rigid visor panel 84 as a single sun shield, or include bifurcated and rigid side panels 86 and 88, pivoted to the side edges of panel 84 and movable to the position shown in FIG. 1 to shield the sides of the case and block not only the sun, but also provide privacy, divert water spray and blowing dust. Each side panel has bend 87 and 89 so that it can be folded in the direction of arrows B, to a size that fits within the area under cover 16 as shown in FIGS. 2 and 3. Strategically located fasteners, such as male and female snaps 90 are provided on the visor panels so that when they are fold up against the inside of cover 16, they stay there. Straps, elastic bands, VELCRO tapes or other fastening means may be used instead to hold the visor assembly in its full (FIG. 2) or partly (FIG. 3) stowed positions.

A clear or translucent, flexible, removable and water proof keyboard shield generally designated 92 is designed to extend and be hold over the keyboard 34 of the laptop body 30 when the laptop is open. Keyboard shield 92 has a main section 94 which may include customized, vacuum molded key and touch pad areas, and an upwardly extending perimeter 96 on all four sides of the rectangular main section 94. Fastening tapes such as VELCRO loop tapes are provided on the outside surface of the front and side sections of the perimeter 96, and mate with the corresponding hook tape 70 that is also provided on the inside, upper surface of the front case wall 20.

The rear section of perimeter 96 can extend under or over the lower edge 63 of clear shield 60 to help keep water and dust away from the laptop parts (FIG. 1). The other three sides help exclude water and duct via the VELCRO attachment. This attachment also allows the keyboard shield to be pulls taught and smooth over the keyboard 34. In the embodiment of FIG. 3, the keyboard shield perimeter extends downwardly and also has outside surface tapes to mate with the margin tape 70 on the side and front walls 24, 26 and 20 of the case base 14.

Non-custom, perfectly flat keyboard shields may also be provided or a set of custom shields 92 can come with the case of the invention to suit various laptop types. The flexibility of the flat shields allow one laptop key to be pressed without pressing adjacent keys on the keyboard 34. The shield or shields may be stored under the trays 40 as in FIG. 2. Polyurethane can be used as the material for the keyboard shield.

Although the keyboard shield can be attached at three sides, it is at least detachably connected at its perimeter to the pair of side walls 24, 26. In an alternate form of the invention, a keyboard shield is not provided at all, or is of the type which engages over the laptop body and keyboard but is not connected to the housing walls.

Some or all of the walls of the case base 14 and cover 16 may be padded to further protect the laptop.

Loops of fabric 98 are sewn onto the bottom or sides of the case base 14, near some or all of the corners of the case. Fixing straps 100 that have one end connected to a reference surface such as the work surface of a boat, by a screw-on male snap 102, are threaded onto each loop 98. The opposite end of each strap 100 has a female snap 104 that snaps to the male snap 102 after the strap has been bent around the loop 98 as shown in FIG. 3. This secures the case 10 to the boat surface, or to any other surface to which the straps 100 are connected. Different securing means may be provided according to the invention, as long as they hold the laptop in place even if the surface to which the laptop is secured, moves.

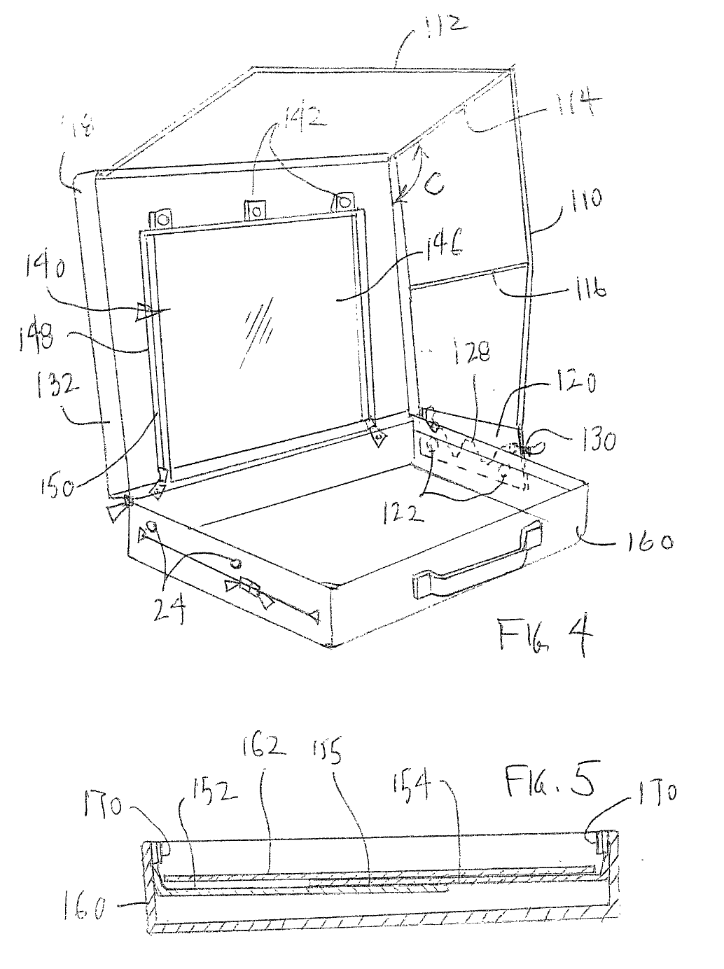

FIGS. 4, 5 and 6 illustrate another embodiment of the invention. In FIG. 4 only one of the usual two side visor panels 110 is shown extending down from the main or top visor panel 112 to which panel 110 is connected at a fold of fabric 114. As with the other embodiments of the invention, panel 110 includes top and bottom semi-rigid panel parts connected to each other at a bend line 116. In order to allow the angle C between the top panel 112 and the case cover 118 to be adjusted, a flexible double walled fabric 120 is attached to the lower edge of panel 110 and has one or more fasteners, such as snaps 122, that are fastened to snaps 124 on the outside surface of the case base 160. An elastic pull cord 128 with locking buttons 130 extends in a tunnel sewn into the fabric 120 along a serpentine path between the two layers of fabric. The opposite ends of the cord 128 extend out through spaced slots in the outer layer of fabric and can be pulled taught and locked by the buttons 130 to gather any excess fabric. Sides 132 of the cover 118 overlap and help cover any small spaces between the inside edges of side panels 110 and the back of the cover that may form depending on the angle C.

FIGS. 4 and 6 also show a clear shield assembly 140 that can be detached from the inside surface of cover 118, via a set, e.g. three, of tabs with snaps 142 that are snapped to snaps 144 in cover 118. The inventor has found that this removable shield assembly is easier to engage over the laptop lid. The assembly has a clear plastic shield 146 fixed at the top edge to an opaque, e.g. black nylon and semi-rigid back panel 148. Side zippers 150 attach the side edges of panels 146, 148, and form an enclosure that is large enough to receive a laptop lid and its display. The shield assembly may then be re-snapped to the cover or left free standing over the laptop lid. Instead of snaps, other fasteners such as VELCRO tape can be used to attach the clear shield assembly to the housing cover.

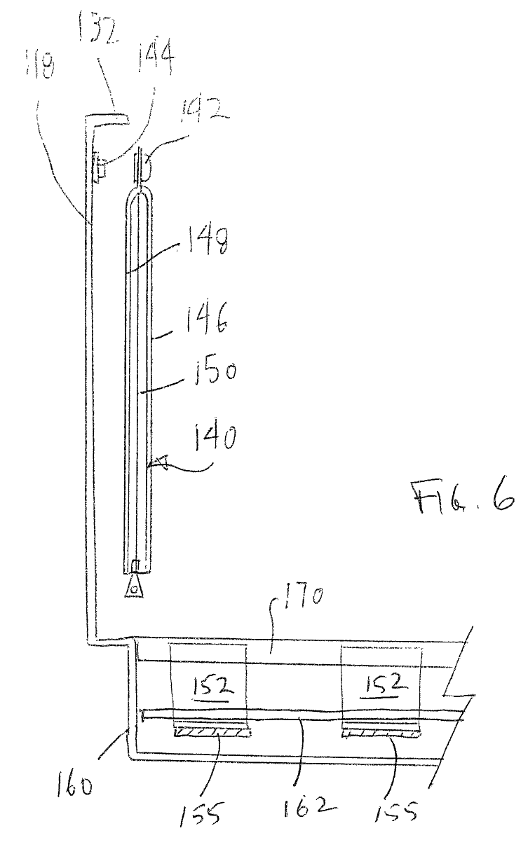

FIGS. 5 and 6 show an alternate embodiment for the height adjusting means of the invention. Rather than the tray means of FIGS. 2 and 3, one or more pairs of VELCRO fastener attached bands 152 and 154 extending from opposite inside walls of the case base 160, and extend under the laptop body and hold it up in the base. The extend of overlap in a VELCRO attached overlap area 155 between the bands 152, 154, sets the height, and for added security a thin but rigid base panel 162 may rest on the bands to support the laptop body. One pair of broad bands 152, 154 may be enough, of two pairs or three pairs, space across the case base 160. The same bands 152 and 154 may be used over the closed laptop to hold it in the case base 160 for storage and transport.

Other height adjustment means may alternatively be used such as multiple sets of four small cylinders of different lengths that can be placed under the four corners of the laptop body to hold it up in the case base 160.

VELCRO fastening tapes 170 are provided over the tops of the bands 152 and 154 for the keyboard shield attachment as in the other embodiments of the invention.

While specific embodiments of the invention have been shown and described in detail to illustrate the application of the principles of the invention, it will be understood that the invention may be embodied otherwise without departing from such principles.

What is claimed is:

1. A water and dust resistant laptop case with privacy feature, comprising:
a housing having a base with a bottom wall, a front wall, a rear wall and a pair of side walls defining a storage space, the housing having a cover connected to the base at the rear wall, the cover having a closed position over the base for closing the storage space and an open position extending upwardly from the rear wall of the base;
height adjustment means in the storage space for adjusting a vertical position of a laptop in the base, the laptop having a body with a keyboard and a lid with a display hinged to the body between an open and a closed position;
slot means defining an access slot in at least one of the rear and pair of side walls for connecting at least one of power and peripherals to the laptop body;
a clear display shield associated with the cover and positioned near an inside surface of the cover, the display shield having means for allow the display shield to be brought in front of the laptop display when the laptop is open with the body in the storage space;
a visor assembly pivotally connected to the cover near a top edge of the cover which is adjacent the front wall of the base when the cover is in the closed position, the visor assembly having a storage position that is substantially parallel to the cover and over the display shield, and a shading position extending outwardly from the top edge of the cover when the cover is in the open position;
fixing means between the cover and the visor assembly for holding the visor assembly in the shading position; and
a flexible keyboard shield extending over the keyboard of the laptop body when the laptop is open, the keyboard shield being detachably connected at its perimeter at least to the pair of side walls.

2. A laptop case according to claim 1, wherein the height adjustment means comprise at least one set of bands connected to the side walls of the base and attachable to each other at an adjustable overlap area under the laptop body for holding the body at different heights in the base.

3. A laptop case according to claim 1, wherein the height adjustment means comprise a rigid panel with a downwardly extending perimeter and fastening means on inside surfaces of at least the side walls to hold the tray to the base and support the laptop body.

4. A laptop case according to claim 1, wherein the slot means are a double zippered slot having a pair of zipper pulls that act in opposite directions to open and close any selected length and location of the slot.

5. A laptop case according to claim 4, including a weather flap over each slot.

6. A laptop case according to claim 1, wherein the slot means are fastening tape closed slots.

7. A laptop case according to claim 6, including a weather flap over each slot.

8. A laptop case according to claim 1, including a pair of vertical fasteners operate at side edges of the clear display shield for releasing the display shield so that it can be brought over the open laptop lid, a lower edge of the display shield being left free.

9. A laptop case according to claim 1, including at least one tab fixed to and extending downwardly from the lower edge of the display shield and engageble to the side walls of the base to smooth and flatten the display shield.

10. A laptop case according to claim 1, wherein the fixing means comprises a pair of friction hinges between the cover and the visor assembly for holding the visor assembly in the shading position.

11. A laptop case according to claim 1, wherein the visor assembly comprises a main rigid visor panel and a pair of bifurcated and rigid side panels pivoted to side edges of the main panel, each side panel being foldable to fit within an area under the cover.

12. A laptop case according to claim 11, including fasteners on the visor panels to hold the visor panels in a stowed position against the case cover.

13. A laptop case according to claim 1, wherein the keyboard shield is clear or translucent and water proof, and has a main section and a perimeter with fastening means for engaging inside surfaces of the side walls of the case base to removably hold the keyboard shield over the laptop body keyboard when in the case base.

14. A laptop case according to claim 13, wherein the keyboard shield perimeter extends to a free lower edge of the display shield.

15. A laptop case according to claim 13, wherein the main section of the keyboard shield is molded to match the laptop keyboard.

16. A laptop case according to claim 13, wherein the main section of the keyboard shield is flat and has flexibility to allow one laptop key to be pressed without pressing adjacent keys on the keyboard.

17. A laptop case according to claim 1, including securing means at least at one corner of the case base for fixing the case to a reference surface.

18. A laptop case according to claim 17, wherein the securing means comprises at least one loop and a securing strap for threading onto the loop.

19. A laptop case, comprising:
a housing having a base with a bottom wall, a front wall, a rear wall and a pair of side walls defining a storage space for a laptop having a body with keyboard and a lid with display, the housing having a cover connected to the base at the rear wall, the cover having a closed position over the base for closing the storage space and an open position extending upwardly from the rear wall of the base;
a flexible keyboard shield extending over the keyboard of the laptop body when the laptop is open, the keyboard shield being detachably connected at lease at opposite sides of the keyboard shield to the pair of side walls; and
detachable elongated fasteners between the opposite sides of the keyboard shield and the pair of side walls for holding the keyboard shield in place in the base.

20. A laptop case according to claim 19, including a closable access slot in at least one of the rear and pair of side walls of the base for connecting at least one of power and peripherals to the laptop body.

21. A laptop case according to claim 19, including a a clear display shield for extending over the laptop display when the laptop is open with the body in the storage space, and a pair of vertical zippers that operate at side edges of the clear display shield si it can be brought over the open laptop lid, a lower edge of the display shield being left free.

22. A laptop case according to claim 19, including a a visor assembly pivotally connected to the cover near a top edge of the cover which is adjacent the front wall of the base when the cover is in the closed position, the visor assembly having a storage position that is substantially parallel to the cover and over the display shield, and a shading position extending outwardly from the top edge of the cover when the cover is in the open position.

23. A laptop case according to claim 22, including a fixing means between the cover and the visor assembly for holding the visor assembly in the shading position.

24. A laptop case according to claim 23, wherein the visor assembly comprises a main rigid visor panel and a pair of bifurcated and rigid side panels pivoted to side edges of the main panel, each side panel being foldable to fit within an area under the cover.

25. A laptop case according to claim 19, including height adjustment means in the base for adjusting the height of the laptop body in the base.

26. A water and dust resistant laptop case with privacy feature, comprising:
a housing having a base with a bottom wall, a front wall, a rear wall and a pair of side walls defining a storage space, the housing having a cover connected to the base at the rear wall, the cover having a closed position over the base for closing the storage space and an open position extending upwardly from the rear wall of the base;
height adjustment means in the storage space for adjusting a vertical position of a laptop in the base, the laptop having a body with a keyboard and a lid with a display hinged to the body between an open and a closed position;
slot means defining an access slot in at least one of the rear and pair of side walls for connecting at least one of power and peripherals to the laptop body;
a clear display shield associated with the cover and positioned near an inside surface of the cover, the display shield having means for allow the display shield to be brought in front of the laptop display when the laptop is open with the body in the storage space;
a visor assembly pivotally connected to the cover near a top edge of the cover which is adjacent the front wall of the base when the cover is in the closed position, the visor assembly having a storage position that is substantially parallel to the cover and over the display shield, and a shading position extending outwardly from the top edge of the cover when the cover is in the open position; and
fixing means between the cover and the visor assembly for holding the visor assembly in the shading position.

27. A laptop case according to claim 26, including a a flexible keyboard shield for extending over the keyboard of the laptop body when the laptop is open.

28. A laptop case according to claim 26, wherein the height adjustment means comprise at least one set of bands connected to the side walls of the base and attachable to each other at an adjustable overlap area under the laptop body for holding the body at different heights in the base.

29. A laptop case according to claim 26, wherein the height adjustment means comprise a rigid panel with a downwardly extending perimeter and fastening means on inside surfaces of at least the side walls to hold the tray to the base and support the laptop body.

30. A laptop case according to claim 26, wherein the slot means are a double zippered slot having a pair of zipper pulls that act in opposite directions to open and close any selected length and location of the slot.

31. A laptop case according to claim 26, wherein the slot means are fastening tape closed slots.

32. A laptop case according to claim 26, including a pair of vertical fasteners operate at side edges of the clear display shield for releasing the display shield so that it can be brought over the open laptop lid, a lower edge of the display shield being left free.

33. A laptop case according to claim 26, including at least one tab fixed to and extending downwardly from the lower edge of the display shield and engageble to the side walls of the base to smooth and flatten the display shield.

34. A laptop case according to claim 26, wherein the fixing means comprises a pair of friction hinges between the cover and the visor assembly for holding the visor assembly in the shading position.

35. A laptop case according to claim 26, wherein the visor assembly comprises a main rigid visor panel and a pair of bifurcated and rigid side panels pivoted to side edges of the main panel, each side panel being foldable to fit within an area under the cover.

36. A laptop case according to claim 35, including fasteners on the visor panels to hold the visor panels in a stowed position against the case cover.

37. A laptop case according to claim 26, including securing means at least at one corner of the case base for fixing the case to a reference surface.
